(19) United States
(12) Patent Application Publication
(10) Pub. No.: US 2007/0135138 A1
(43) Pub. Date: Jun. 14, 2007

(54) Methods, systems, and computer program products for providing location based subscription services

(75) Inventors: Michael S. Brown, Raleigh, NC (US); Shruti Gandhi, Poughkeepsie, NY (US); Salim Halim, Cary, NC (US); Konrad C. Lagarde, Milford, CT (US); Jessica Wu Ramirez, Danbury, CT (US); Richard Rogers, Raleigh, NC (US)

Correspondence Address: CANTOR COLBURN LLP-IBM YORKTOWN, 55 GRIFFIN ROAD SOUTH, BLOOMFIELD, CT, 06002, US

(73) Assignee: INTERNATION BUSINESS MACHINES CORPORATION, ARMONK, NY (US)

(21) Appl. No.: 11/302,854

(22) Filed: Dec. 13, 2005

(51) Int. Cl. H04Q 7/20

(52) U.S. Cl. 455/456.3

(57) ABSTRACT

Methods, systems, and computer program products for providing location based subscription services. The methods include receiving a geographic location of a user. The user is subscribed to an on-line community if the on-line community specifies a community location that is within a distance of the geographic location of the user, and the user is not currently subscribed to the on-line community. The user is un-subscribed from the on-line community if the community location is not within the distance of the geographic location of the user and the user is currently subscribed to the on-line community. Embodiments further include computer program products for implementing the methods.

### BACKGROUND

The present disclosure relates generally to subscription services and, in particular, to methods, systems, and computer program products for providing location based subscription services.

Computer systems that capture the location (presence) of an individual at a given point in time are commercially available. Known solutions include static capture of location in employee or community directories. A drawback is that people are mobile, they are not always at the “home” location listed in a directory. Another known solution is to dynamically capture location based on a user's device location in a computer network at a given point in time. This allow for dynamic understanding of location. A drawback is that this does not by default provide a spatial (geographic) understanding of the individual location in relation to other individuals in a given “group” (e.g., there are x number of individuals from a given group that are currently located y distance from a given landmark). The industry term for geographically depicting a location is geocoding. An additional drawback is that this does not reflect future location plans (e.g., where does this individual plan to be next Tuesday).

Community interaction technology (e.g., instant messaging systems, chat boards, forums, websites, etc.) do not reflect spatial information about community members. Where an individual is physically located at a given point in time is not provided. Users of these systems and managers of these communities do not have this information. Without spatial understanding of individuals in a group at a given point in time, questions such as the following cannot be easily answered. Who is/will be in a given region at a certain time? What is the best time/location for an event that will minimize travel needs for a target group? What individuals from the group that meet certain criteria (e.g., skill, role) are in a given location at a given point in time? What is the current location of the person I am engaging via chat or instant messaging? What is the best time of day to conduct a call for a target audience to maximize convenience, given time zone differences? For a given community, which regions should be targeted for membership drives, skills enhancements, etc.

Currently, there is a lack of an intelligent, need-based data delivery system. User mailboxes get flooded with static, generic information from a “home” location. Even push-based information needs to be updated at the user location. This makes it inconvenient for users to receive information regarding the west coast today and the mid-west tomorrow when they are registered at a home location on the east coast.

For a given set or group of people, information and information analysis about where they physically plan to be at a given point in time in the future is not readily accessible from information systems available today. There are geographic information systems (e.g., ESRI products) and there are collaboration and calendaring systems (e.g., Lotus). What is needed is an integration between these two types of systems to allow information analysis regarding geographic locations of group members at given points in time, including the future.

### BRIEF SUMMARY

Exemplary embodiments include methods, systems, and computer program products for providing location based subscription services. The methods include receiving a geographic location of a user. The user is subscribed to an on-line community if the on-line community specifies a community location that is within a distance of the geographic location of the user, and the user is not currently subscribed to the on-line community. The user is un-subscribed from the on-line community if the community location is not within the distance of the geographic location of the user and the user is currently subscribed to the on-line community. Embodiments further include computer program products for providing the methods.

Additional exemplary embodiments include systems for providing location based subscription services. The systems include a processor and computer instructions executing on the processor. The computer instructions facilitate receiving a geographic location of a user. The user is subscribed to an on-line community if the on-line community specifies a community location that is within a distance of the geographic location of the user, and the user is not currently subscribed to the on-line community. The user is un-subscribed from the on-line community if the community location is not within the distance of the geographic location of the user and the user is currently subscribed to the on-line community.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a block diagram of components accessed by location based subscription services in exemplary embodiments;

FIG. 2 is a flow diagram describing a process for location based subscription services in exemplary embodiments;

FIG. 3 is a flow diagram describing a process for location based subscription services including using a future location in exemplary embodiments; and

FIG. 4 depicts a system upon which location based subscription services may be implemented in exemplary embodiments.

The detailed description explains the preferred embodiments of the invention, together with advantages and features, by way of example with reference to the drawings.

### DETAILED DESCRIPTION

Exemplary embodiments apply spatial technology (e.g,, geographic information systems) to the field of expertise location, community and community technology (e.g., instant messaging) and knowledge management. Information is pushed to users based on their location, preferences, context and community. Mechanisms like GPS, cellular telephones, PDAs, and computer network locations exist today for capturing a current location of an individual in both static and dynamic modes. Exemplary embodiments expand upon this to integrate calendaring systems and collaboration software (e.g., Lotus Workplace, Lotus Notes) with geospatial capabilities. Future planned locations of individuals are captured via the use of calendaring systems. In addition, current location is expanded to geocode (i.e., depicts) the current location information. Geocoding is accomplished (statically and/or dynamically) using existing geographic information systems technology (e.g., ESRI, DB2 Spatial Extender).

An example scenario that may be implemented by exemplary embodiments follows. A user registered in Poughkeepsie, N.Y. has listed his preferences as coffee and Mexican food. He is part of the Starbucks community, a dynamic Poughkeepsie community and a Chilli's community. His calendar has a future scheduled visit to Southbury, Conn. on Tuesday, Dec. 7, 2004 at 8:30 a.m. from Poughkeepsie. In exemplary embodiments, the following actions would occur:
The user is automatically notified of any Mexican food and coffee places located within his specified radius of search.
The user is provided with further information such as directions, restaurant ratings and a website if he requests further information.
The user will receive alerts from users in the communities he is subscribed to.
Based on a calendar entry of the user, the user will have directions from Poughkeepsie, N.Y. to Southbury, Conn. appended to his meeting notice.
While in Poughkeepsie, N.Y., the user is automatically part of a dynamic location-based community in Poughkeepsie. When his location changes to Southbury, he gets subscribed to the location-based community in Southbury. At the same time, he is un-subscribed to the dynamic community in Poughkeepsie.
The user is notified of the nearby Starbucks and Chilli's in Southbury.
At a given time and location, Starbucks and Chilli's can keep track of the number of members subscribed to their communities and alert users of an instant deal respectively. For example, on a cold snowy day, if Starbucks sees 250 subscribed users nearby, they can run an instant deal of “buy a tall while mocha and get a cookie free.” This instant deal may be broadcast to the 250 subscribed users nearby.
Based on the future plan details available from calendar systems and community subscriptions, the Southbury site cafeteria services can decide to run a special menu because they know of at least 250 visitors visiting Southbury.

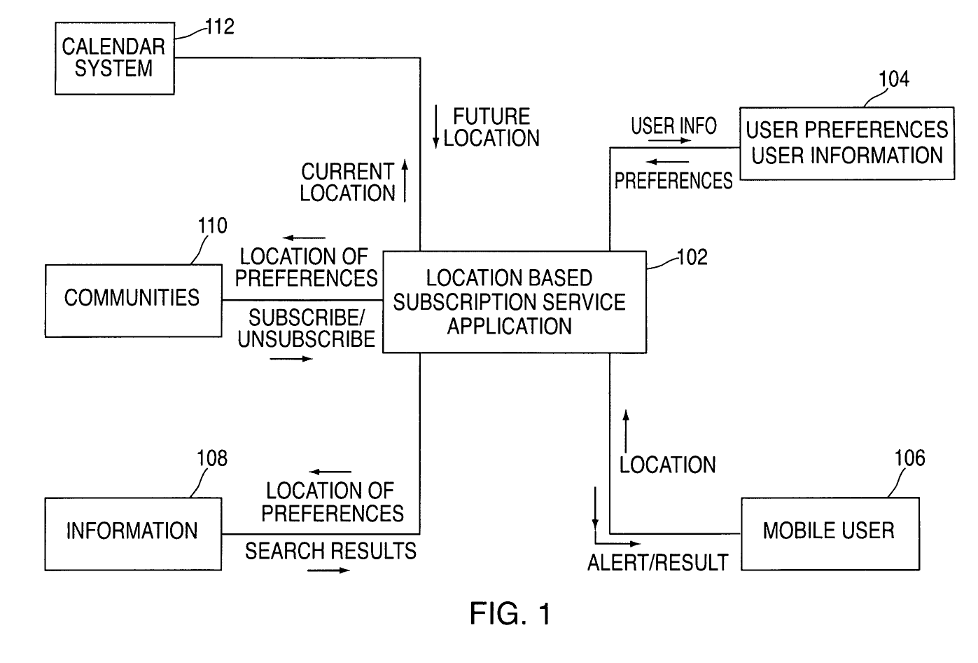

FIG. 1 is a block diagram of components accessed by location based subscription services in exemplary embodiments. A location based subscription service application 102 interfaces with a calendar system 112, a mobile user 106 and several data stores including a user preferences and user information data store 104, a communities data store 110 and a location information data store 108. The location based subscription service application 102 receives user location information from the mobile user 106. After performing the processing described herein, the location based subscription service application 102 transmits information (responsive to the user location and user preferences) to the mobile user 106. The location based subscription service application 102 sends user information (e.g., a user identifier of the user) to the user information data store 104 and receives preferences for the user from the user preferences and user information data store 104. The user preferences and user information data store 104 includes data such as preferences associated with the users and user information. User preferences can include, but are not limited to, categories such as restaurant names, food types, preferred stores, gas stations, hobbies, professional affiliations, etc. These preferences are utilized to determine what information from the location information data store 108 should be provided to the user. In addition, these preferences are utilized to determine on-line communities that would be of interest to the user. In exemplary embodiments, the preferences are contained in a database that is updated by the user via a database editing tool.

The location based subscription service application 102 also communicates with the location information data store 108 to retrieve information relevant to the user preferences and to a geographic location of the user. The location information data store 108 includes information such as nearby tourist attractions, restaurants, weather, traffic conditions etc.. The data in the location information data store 108 is grouped based on geographic location and includes one or more keywords to describe the type of data. Each piece of data in the location information data store 108 may be unique to a particular geographic location. The data in the location information data store 108 is retrieved by the location based subscription service application 102 based on the user preferences for the user and geographic location of the user.

The location based subscription service application 102 also communicates with the communities data store 110 to retrieve a list of communities available at the geographic location of the user that match the user preferences. The location based subscription service application 102 then subscribes to the retrieved list of on-line communities returned by the communities data store 110. The location based subscription services application 102 also verifies, against the information contained in the communities data store 110, that that the user should continue to subscribe to the on-line communities where he already has a subscription. The location based subscription service application 102 then subscribes or un-subscribes to on-line communities based on the information contained in the communities data store 110. In exemplary embodiments, the communities data store 110 includes a list of on-line communities as well as a subject(s) of the community and a geographic location (or geographic region) of the community.

In exemplary embodiments, the location based subscription service application 102 also communicates with a calendar system 112 such as Lotus Notes. The calendar system 112 includes current and planned future locations of the user. As described below, the planned future location of the user may be utilized for a variety of purposes including, but not limited to, providing information about the planned future location to the user, creating a map with a path from one location to another location with information about geographic locations on the path and/or alerting an on-line community in the planned future location of the planned arrival of the user. The block diagram depicted in FIG. 1 is meant to be exemplary in nature. Other implementations are possible without departing from the scope of the invention.

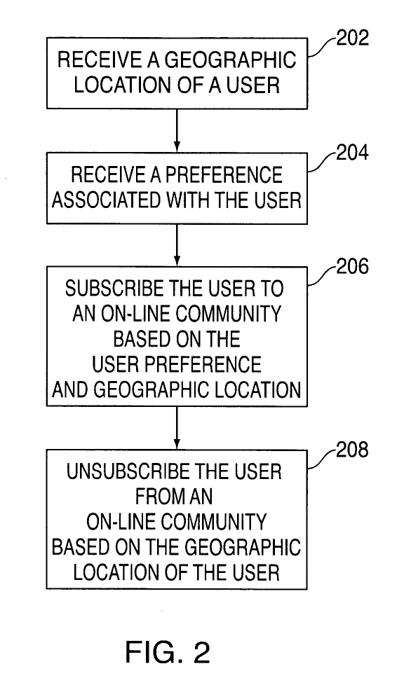

FIG. 2 is a flow diagram describing a process for location based subscription services in exemplary embodiments. At block 202, a geographic location of a user is received from a user device. In exemplary embodiments, the geographic location is expressed as a global positioning system (GPS) coordinate and the user is identified by a userid. At block 204, preferences associated with the user are received from the user preferences and user information data store 104. In exemplary embodiments, the preferences are received as a result of a request from the location based subscription service application 102 for the user preferences.

At block 206, the user is subscribed to none, one, or multiple on-line communities based on the available on-line communities, the user preferences and the geographic location of the user. The location based subscription service application 102 may request a list of all on-line communities specifying a community location that is within a specified distance of the geographic location of the user and has a subject that matches the user preferences. The list is requested by the location based subscription service application 102 from the communities data store 110. The communities data store 110 includes a list of all on-line communities, along with their subject(s) and community locations (e.g., a GPS coordinate or a GPS region/range). The subject(s) of the on-line communities are compared to the user preference(s) to find a match between them. For some user preferences, a match could require that the preferences have a key word (or a portion of a keyword) in common with the subject; for other user preferences a match could require that the user preferences have a specific phrase in common (e.g., for specifying a particular store or restaurant) with the subject.

At block 206 in FIG. 2, the user is subscribed to one or more on-line communities that he is not currently subscribed to if the on-line community specifies a community location that is within a specified distance of the geographic location of the user, and one or more of the subjects of the on-line community match one or more of the preferences associated with the user. Once the user is a member of the on-line community, the user may receive messages (e.g., broadcast and/or one-to-one) from other members of the community. In addition, the user could be alerted if one of the other members of the on-line community is within a user specified distance (e.g., three meters, one mile, etc) from the user. The user could initiate a specific communication with other members within the specified distance from the user.

At block 208, the user is un-subscribed to one or more on-line communities that he is currently subscribed to if he is no longer within a specified distance of the community location. The processing depicted in FIG. 2 may be executed by the location based subscription service application 102 on a periodic basis (e.g., every millisecond, every second, every minute) for each user. Alternatively, the processing depicted in FIG. 2 is executed when the geographic location of the user changes by a specified amount (e.g., a meter, a kilometer, etc.).

In alternate exemplary embodiments, preferences are not received at block 204 and the processing depicted in FIG. 2 is performed based solely on the geographic location of the user. Therefore, the subscribing and un-scribing are performed based only on the geographic location of the user.

In exemplary embodiments, information from the location information data store 108 may also be accessed based on the geographic location of the user and the user preferences. Information about restaurants, stores, etc with keywords that match the preferences specified by the user and are within a specified distance of the user may be retrieved from the location information data store 108. This information may then be transmitted to the user. Information in the location information data store 108 may also include environmental data such as weather and traffic which may be retrieved from another source when requested by the location based subscription service application 102.

Exemplary embodiments also allow the user to create a new on-line community. The user would specify a geographic location (or region) and subject(s) for the on-line community.

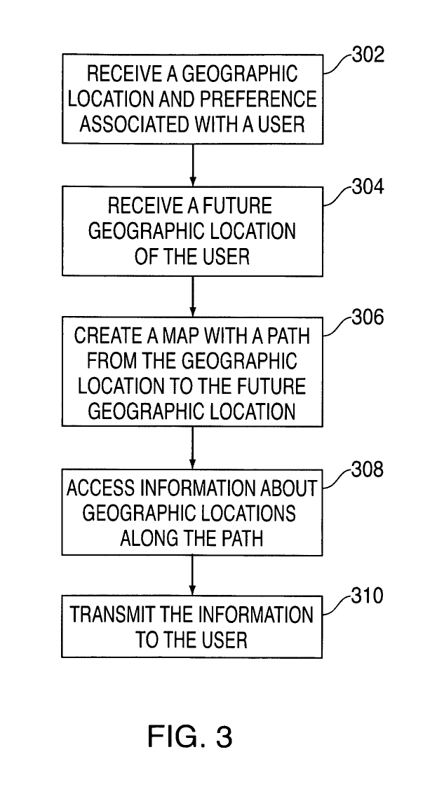

FIG. 3 is a flow diagram describing a process for location based subscription services including using a future location in exemplary embodiments. At block 302, a geographic location of a user and a preference associated with the user are received. At block 304, a planned future geographic location of the user is received. In exemplary embodiments, the future geographic location of the user is received in response to a request to a calendaring system 112 from the location based subscription service application 102. The calendaring system 112 contains planned locations for the user at specific time slots in the future.

At block 306, a map is created, including a path from the current geographic location of the user to the future geographic location of the user. In exemplary embodiments, the map is created by off the shelf mapping software that is initiated by the location based subscription service application 102. At block 308, information about geographic locations along the path from the current geographic location to the future geographic location is retrieved from the location information data store 108. The information is retrieved based on the use preferences. At block 310, the information is transmitted to the user. In exemplary embodiments the transmitting includes transmitting the map (text, voice, graphic) with the information highlighted on the map. In this manner, the user can be directed to favorite fast food chains and/or stores associated with his hobbies along the route from his current geographic location to his planned future geographic location.

In alternate exemplary embodiments, preferences are not received at block 302 and the processing depicted in FIG. 3 is performed based solely on the geographic location of the user. Therefore, at block 308, the information about the geographic locations along the path is retrieved based only on the geographic locations.

In exemplary embodiments, the map is created between two planned future geographic locations of the user. In this case, the geographic location of the user is the first planned future geographic location of the user and the future geographic location of the user is the second planned future geographic location of the user.

In exemplary embodiments, information about the future geographic location (that is responsive to user preferences) is retrieved from the location information data store 108. This information is transmitted to the user. In this manner, a user may plan places to eat and visit at the planned future location.

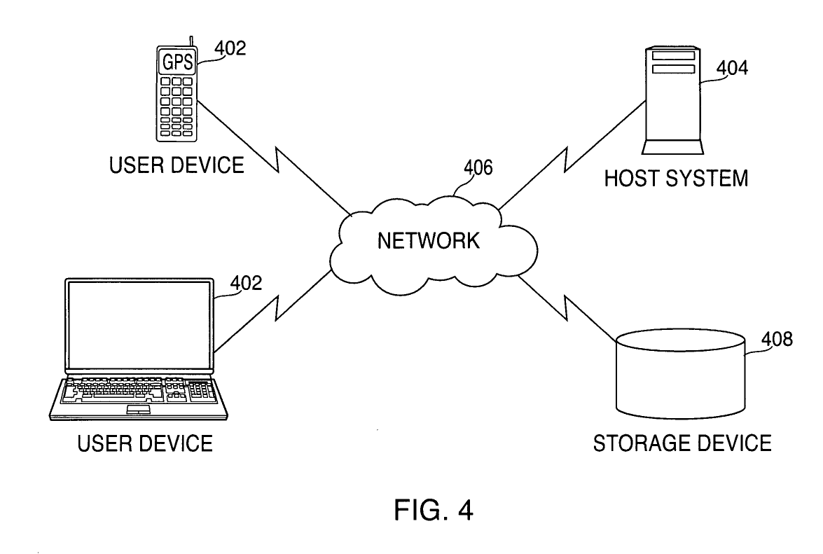

FIG. 4 depicts a system upon which location based subscription services may be implemented in exemplary embodiments. The system includes one or more user devices 402 through which mobile users 106 at one or more geographic locations may contact the host system 404 to access the location based subscription service application 102 described herein. In exemplary embodiments, the host system 404 includes a processor with instructions to execute the location based subscription service application 102 to facilitate the finctions described herein. The location based subscription service application 102 may be implemented by software and/or hardware components. In exemplary embodiments, the location based subscription service application 102 is in communication with a calendar system 112 and mapping software (if maps are being created) to perform portions of the processing described herein. In exemplary embodiments, the user devices 402 are coupled to the host system 404 via a network 406.

Each user device 402 may be implemented using a general-purpose computer executing a computer program for carrying out the processes described herein. The user devices 402 may be personal computers, lap top computers, personal digital assistants, cellular telephones, host attached terminals, etc. with user interfaces for communicating with the location based subscription service application 102. The user interfaces may be implemented by interface screens, audio technology, voice recognition technology, or any other technology to allow the user device and the location based subscription service application 102 to communicate. In addition, the user devices 402 include a device for determining a geographic location of the user device 402 (e.g., a GPS device). If the user devices 402 are personal computers (or include the required functionality), the processing described herein may be shared by a user device 402 and the host system 404 (e.g., by providing an applet to the user device 402) or contained completely within one or more of the user devices 402.

The network 406 may be any type of known network including, but not limited to, a wide area network (WAN), a local area network (LAN), a global network (e.g. Internet), a virtual private network (VPN), and an intranet. The network 406 may be implemented using a wireless network or any kind of physical network implementation. A user device 402 may be coupled to the host system 404 through multiple networks (e.g., intranet and Internet) so that not all user devices 402 are coupled to the host system 404 through the same network. One or more of the user devices 402 and the host system 404 may be connected to the network 406 in a wireless fashion.

The storage device 408 may be implemented using a variety of devices for storing electronic information. It is understood that the storage device 408 may be implemented using memory contained in the host system 404 or the user device 402 or it may be a separate physical device. The storage device 408 is logically addressable as a consolidated data source across a distributed environment that includes a network 406. Information stored in the storage device 408 may be retrieved and manipulated via the host system 404. The storage device 408 includes the user preferences and the user information data store 104, the communities data store 110 and the location information data store 108. The storage device 408 may also include other kinds of data such as system logs and other administrative data. In exemplary embodiments, the host system 404 operates as a database server and coordinates access to application data including data stored on storage device 408.

The host system 404 depicted in FIG. 4 may be implemented using one or more servers operating in response to a computer program stored in a storage medium accessible by the server. The host system 404 may operate as a network server (e.g., a web server) to communicate with the user device 402. The host system 404 handles sending and receiving information to and from the user device 402 and can perform associated tasks. In addition, the host system 404 also communicates with the network resources to cause the requested service to be added to the network. The host system 404 may also include a firewall to prevent unauthorized access to the host system 404 and enforce any limitations on authorized access. For instance, an administrator may have access to the entire system and have authority to modify portions of the system. A firewall may be implemented using conventional hardware and/or software.

The host system 404 may also operate as an application server. The host system 404 executes one or more computer programs (e.g., via a processor on the host system 404) to implement the location based subscription service application 102. Processing may be shared by the user device 402 and the host system 404 by providing an application (e.g., java applet) to the user device 402. Alternatively, the user device 402 may include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

Exemplary embodiments manage all location information and execute intelligence logic on a server as opposed to on a local system. This removes the requirement to keep the information up to date from the user and moves it to the service provider. Basically, it makes the user device a “thin client” and provides a more central point of maintenance. Additionally, exemplary embodiments include the elements of community and advanced preferences. A user can, for example, specify that he or she enjoys a particular type of food (eg., Chinese, Mexican) instead of requesting the locations of a specific Chinese restaurant chain. This is the shift from a pull based to a push based implementation. Instead of a user having to “pull” something (e.g., “Show me all of the Italian restaurants within x miles of the 27709 zip code”), exemplary embodiments “push” suggestions towards the user (e.g., all nearby restaurants, coffee shops, etc. that match the user's preferences/criteria are displayed on the user's user device 402). Exemplary embodiments allow a user to move in and out of local on-line communities as he travels from one geographic location to another. This may lead to more specific and more accurate information pertaining to the user's preferences being presented to the user while he is traveling.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for providing location based subscription services, the method comprising:
receiving a geographic location of a user;
subscribing the user to an on-line community if the on-line community specifies a community location that is within a distance of the geographic location of the user, and the user is not currently subscribed to the on-line community; and
un-subscribing the user from the on-line community if the community location is not within the distance of the geographic location of the user and the user is currently subscribed to the on-line community.

2. The method of claim 1 further comprising receiving a preference associated with the user, wherein the user is subscribed to the on-line community if a subject of the on-line community matches the preference associated with the user, if the on-line community specifies a community location that is within the distance of the geographic location of the user, and the user is not currently subscribed to the on-line community.

3. The method of claim 2 further comprising accessing information about the geographic location based on the preference associated with the user.

4. The method of claim 3 further comprising transmitting the information to the user.

5. The method of claim 2 wherein the preference includes one or more of a hobby, a business interest, a restaurant type, a restaurant name, a store type, and a store name.

6. The method of claim 2 further comprising:
receiving a future geographic location of the user;
accessing information about the future geographic location based on the preference associated with the user; and
transmitting the information about the future geographic location to the user.

7. The method of claim 2 further comprising:
receiving a future geographic location of the user;
creating a map including a path from the geographic location of the user to the future geographic location of the user;
accessing information about geographic locations along the path based on the preference associated with the user; and
transmitting the information about the geographic locations along the path to the user.

8. The method of claim 1 further comprising accessing information about the geographic location.

9. The method of claim 8 further comprising transmitting the information to the user.

10. The method of claim 1 further comprising:
receiving a request from the user to create a new on-line community; and
creating the new on-line community in response to the request, the creating including specifying a geographic location.

11. The method of claim 10 wherein the creating further includes specifying a subject of the new on-line community.

12. The method of claim 1 wherein the distance is specified by the user.

13. The method of claim 1 further comprising:
receiving a future geographic location of the user;
accessing information about the future geographic location; and
transmitting the information about the future geographic location to the user.

14. The method of claim 13 further comprising transmitting a request to a calendar system for the future geographic location of the user, wherein the receiving a future geographic location of the user is in response to transmitting the request the calendar

15. The method of claim 1 further comprising:
receiving a future geographic location of the user;
creating a map including a path from the geographic location of the user to the future geographic location of the user;
accessing information about geographic locations along the path; and
transmitting the information about the geographic locations along the path to the user.

16. The method of claim 1 further comprising:
receiving a future geographic location of the user; and
notifying on-line communities at the future geographic location that the user will be arriving at the future geographic location.

17. The method of claim 1 wherein members of the on-line community transmit and receive messages from other member of the on-line community.

18. A system for providing location based subscription services, the system comprising:
a processor; and
computer instructions executing on the processor for facilitating:
receiving a geographic location of a user;
receiving a preference associated with the user;
subscribing the user to an on-line community if the on-line community specifies a community location that is within a distance of the geographic location of the user, and the user is not currently subscribed to the on-line community; and
un-subscribing the user from the on-line community if the community location is not within the distance of the geographic location of the user and the user is currently subscribed to the on-line community.

19. The system of claim 18 further comprising receiving a preference associated with the user, wherein the user is subscribed to the on-line community if a subject of the on-line community matches the preference associated with the user, if the on-line community specifies a community location that is within the distance of the geographic location of the user, and the user is not currently subscribed to the on-line community.

20. A computer program product for providing location based subscription services, the computer program product comprising:
a storage medium readable by a processing circuit and storing instructions for execution by the processing circuit for facilitating a method comprising:
receiving a geographic location of a user;
subscribing the user to an on-line community if the on-line community specifies a community location that is within a distance of the geographic location of the user, and the user is not currently subscribed to the on-line community; and
un-subscribing the user from the on-line community if the community location is not within the distance of the geographic location of the user and the user is currently subscribed to the on-line community.
